(19) United States
(12) Patent Application Publication
(10) Pub. No.: US 2012/0261992 A1
(43) Pub. Date: Oct. 18, 2012

(54) Renewable Energy Power Controller

(76) Inventors: Francis J. Parker, Cooper City, FL (US); Robert Crawbuck, Jupiter, FL (US); Emilian Padurariu, West Palm Beach, FL (US); David McClurkin, Knoxville, TN (US)

(21) Appl. No.: 13/444,064

(22) Filed: Apr. 11, 2012

Related U.S. Application Data
(60) Provisional application No. 61/475,928, filed on Apr. 15, 2011.

(51) Int. Cl. H02J 9/00

(52) U.S. Cl. 307/64

(57) ABSTRACT

A system to provide power to a load from a renewable power source and an energy storage device, comprises input and isolation circuits for receiving power from renewable energy sources and to isolate each renewable energy source from one other, a battery charger circuit to charge a battery by receiving power from the renewable energy sources, a DC-to-AC power inverter having an input connected to the battery and an AC output to match an AC backup power source, and a switching circuit which connects the AC inverter input to a load, and switches to connect the AC backup power to the load when the battery voltage drops below a certain level.

### CROSS REFERENCE TO RELATED APPLICATION

This application claims priority to U.S. Provisional Application Ser. No. 61/475,928, filed Apr. 15, 2011, which is incorporated herein by reference.

### BACKGROUND OF THE INVENTION

The present invention relates to a system and method for providing stored electrical power from renewable energy sources to a load, The load can be any one of a number of load types, such as a lighting ballast, electrically powered sign, or other electrical load.

Solar power has been used to power electrical loads, thereby reducing dependency on other energy sources such as fossil fuels. However, by the very nature of solar power, interruptions are likely due to overcast days and the harvested energy may therefore not be adequate to power the load for the required duration of operation. The same holds true for other renewable power sources such as wind, which is not always present in sufficient speed to suitably drive a windmill, turbine or like device. There are also applications III which clue to size, constraints it is not possible to utilize a storage battery of adequate ampere-hour rating to provide sufficient energy to run the load for the full operating period.

### SUMMARY INVENTION

The present invention uses the AC line or sonic other source of standby power to automatically provide load output in the case when energy stored in a battery or the like is depleted or not available.

According to the invention, a plurality of renewable energy sources may be used to charge a battery via separate input channels. Either AC or DC input power may he provided on a channel, each of which is isolated from the other channels via a circuit such as a diode or bridge rectifier.

According to the invention, a system is provided to provide power to a load from a renewable power source and an energy storage device, in which backup power is provided by a backup power source when the renewable energy source is not available and the stored power is depleted, comprising a plurality of input and isolation circuits for receiving power from plurality of renewable energy sources and to isolate each of the plurality of renewable energy sources from one other, a battery charger circuit to charge at least one battery by receiving power from at least one of the renewable energy sources, a DC-to-AC power inverter having an input connected to the battery and an AC output to match an AC backup power source, and a switching circuit which connects the AC inverter output to a load, and switches to connect the AC backup power to the load when the battery voltage drops below a certain level.

Preferably, the switching circuit disconnects all power to the load when AC backup power is unavailable, and connects the battery charger circuit to the battery when the source of renewable energy is available. Preferably, the battery provides power to the inverter and load, and simultaneously undergoes charging when the source of renewable energy is available an stored energy in the battery adequate o power the inverter and load.

Preferably, the system includes a time delay switch to change over between AC backup power and battery inverter power to reduce hunting due to fluctuating voltage.

The AC backup power may comprise at least one of an AC utility power line and stand-by AC generator. The AC backup power may be connected indirectly by at least one of a transformer and voltage converter/conditioner.

The load may be an electrically operated sign, light or other electrically powered item, The renewable energy source may be at least one of solar power and wind power.

The input and isolation circuit may comprise at least one of a diode and diode bridges. The battery may comprise a bank of batteries. The switching circuit may comprise a relay. The switching circuit may comprise a time delay relay. The system may further comprise a load switch for selectively delivering power to the load. The load switch may comprise at least one of an external time switch and a photo sensor to detect absence of ambient light. The DC-to-AC inverter may be provided with low voltage detection on its input, which results in the inverter shutting down to prevent excessive and life-shortening discharge of the battery.

The DC-to AC inverter may have a hysteresis circuit so that the required start voltage is higher than the shut down voltage to prevent repeated cycling on and off of the inverter, after shut down, due to the slight rise of battery voltage as the load is removed.

The invention also provides a method to provide power to a load from a renewable power source and an energy storage device, in which backup power is provided by a backup power source when the renewable energy source is not available and the stored power is depleted, comprising receiving power from a plurality of renewable energy sources which are isolated from one other, charging at least one battery by receiving power from at least one of the renewable energy sources, inverting the DC output from the battery to an AC output to match an AC backup power source, and connecting the AC inverted output to a load, and switching to connect the AC backup power to the load when the battery voltage drops below a certain level.

### BRIEF DESCRIPTION OF THE DRAWING

FIG. 1 shows an electrical circuit according to the invention, in which renewable energy is used to power a load, such as a sign.

### DETAILED DESCRIPTION OF A PREFERRED EMBODIMENT

A preferred embodiment will be described to provide one example of using the invention, but the invention is not limited to this embodiment. The embodiment will be described using an illuminated sign as the electrical load. However, the invention is applicable to other loads, such as lighting ballasts, and even non-sign applications.

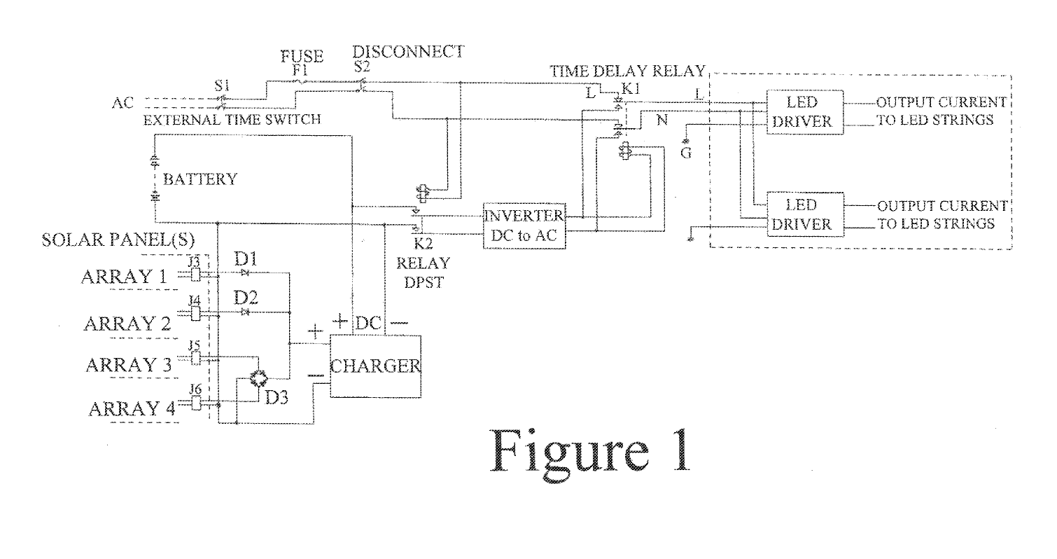

FIG. 1 shows an illuminated sign powered by a power control unit according to the invention. Solar power is harvested from a multiplicity of solar panels, identified as Photovoltaic Arrays 1 through 4. While four such arrays are shown, there is no limit on the number of arrays.

Each solar panel is isolated from the others by means of an isolation circuit in the form of a diode (rectifier), such as D1 and D2 in FIG. 1. The isolation circuit prevents a malfunctioning array from affecting power collection from the others, and prevents reverse current flow. As a practical convenience, a bridge rectifier may be used to isolate two power sources, and as these may be chassis mounted, can simplify assembly. D3 in FIG. 1 illustrates the use of a bridge rectifier.

The cathode side of the diodes are connected together to sum the power from the solar panels, and the resulting DC power is then fed to a battery charger, which is optimized for operation with the selected solar panels and storage battery. The solar panels should be capable of providing sufficient voltage to drive the battery charger for the application, in this case an illuminated sign. The battery charger may be provided with remote voltage sensing leads connected directly to the storage battery to compensate for any voltage drop in the charging circuit and to prevent overcharging of the battery.

Illuminated signs are normally powered up during the evening hours, using either an external time switch (or a photo sensor to detect ambient light) to provide AC power to the sign. This is indicated by switch S1 in FIG. 1. A fuse F1 provides protection for the input wiring in the event of over current failures in the equipment, and that in turn feeds a disconnect switch, which is customary in signs to allow service personnel to service the sign.

AC voltage from the disconnect switch provides power to a coil of a normally open AC relay K2. The AC power is then routed through the normally closed section of the change over contacts of AC relay K1 to the AC input connections of a plurality of LED drivers, which in turn power the LED modules in the illuminated sign.

The contact set of relay K2 connects the storage battery to the input of a DC to AC inverter, which is rated to operate from the battery voltage, and to provide an AC output comparable to the AC line voltage. The inverter is provided with low voltage detection on its input, which results in the inverter shutting down to prevent excessive and life shortening discharge of the battery. There is also hysteresis in the input circuit of the inverter such that the required start voltage is higher than the shut down voltage to prevent repeated cycling on and off of the inverter, after shut down, due to the slight rise of battery voltage as the load is removed.

In the absence of AC power, as is the case during daylight hours, there will be no power to the sign as either the external timer switch will be off, or the photo sensing switch will detect ambient light and be off, and K2 will be de-energized. Under this condition normal battery charging will take place.

During night hours, when the timer switch or photo sensor operates and AC is present, relay K2 closes and the inverter receives DC power from the battery. AC Mains backup power will flow directly to the LED drivers and momentarily power up the illuminated sign until K1 is energized. Upon energizing K1, inverter power will begin to power the illuminated sign.

The nature of inverters is such that the output does not immediately rise to full rated voltage, but rises slowly. if relay K1 were a conventional mechanical relay operating from the output of such an inverter, there would be contact chatter until full operating voltage was attained by the inverter. This would result in the AC power to the LED driver switching rapidly between the AC line voltage and the output of the inverter, causing flashing of the display. The use of the time delay relay allows the output of the inverter to stabilize before the contacts of K1 change over and allow the LED drivers to operate from the output of the inverter,

The sign will continue to run from the battery—inverter combination until either the timer switch/photo sensor S1 opens and removes AC power, deactivating relay K2 and so powering down the inverter, or alternately the storage battery discharges to such a voltage that the inverter then shuts down due to a low voltage condition being detected. In the latter case of the battery discharging, relay K1 is deactivated and power will now flow directly from the AC line via the disconnect switch and K1 contact set to the LED drivers, and will maintain sign illumination until shut down by operation of the timer switch/photo sensor S1.

Although one embodiment of the invention has been shown and described, it will be apparent to those skilled in the art that the embodiment can be modified or used to drive other loads. Accordingly, the invention is not limited to the embodiment described, and the scope of the invention is defined only by way of the following claims.

We claim:

1. A system to provide power to a load from a renewable power source and an energy storage device, in which backup power is provided by a backup power source when the renewable energy source is not available and the stored power is depleted, comprising:
a plurality of input and isolation circuits for receiving power from a plurality of renewable energy sources and to isolate each of the plurality of renewable energy sources from one other;
a battery charger circuit to charge east one battery by receiving power from at least one of the renewable energy sources;
a DC-to-AC power inverter having an input connected to the battery and an AC output to match an AC backup power source; and
a switching circuit which connects the AC inverter output to a load, and switches to connect the AC backup power to the load when the battery voltage drops below a certain level.

2. The system of claim 1, wherein the switching circuit disconnects all power to the load when AC backup power is unavailable, and which connects the battery charger circuit to the battery when the source of renewable energy is available.

3. The system of claim 1, wherein the battery provides power to the inverter and load, and simultaneously undergoes charging when the source of renewable energy is available and the stored energy in the battery is adequate to power the inverter and load.

4. The system of claim 1, including a time delay switch to change over between AC backup power and battery inverter power to reduce hunting due to fluctuating voltage.

5. The system of claim 1 wherein the AC backup power comprises at least one of an AC utility power line and stand-by AC generator.

6. The system of claim 1, wherein the AC backup power is connected indirectly by at least one of a transformer and voltage converter/conditioner.

7. The system of claim 1, wherein the load is an electrically operated sign, light or other electrically powered item.

8. The system of claim 1, wherein the renewable energy source is at least one of solar power and wind power.

9. The system of claim 1, wherein the input and isolation circuit comprises at least one of a diode and diode bridges.

10. The system of claim 1, wherein the battery comprises a bank of batteries.

11. The system of claim 1, wherein switching circuit comprises a relay.

12. The system of claim 1, wherein the switching circuit comprises a time delay relay.

13. The system of claim 1, further comprising a load switch for selectively delivering power to the load.

14. The system of claim 13, wherein the load switch comprises at least one of an external time switch and a photo sensor detect absence of ambient light.

15. The system of claim 1, wherein DC-to-Ac inverter is provided with low voltage detection on its input, which results in the inverter shutting down to prevent excessive and life-shortening discharge of the battery.

16. The system of claim 1, wherein the DC-to AC inverter has a hysteresis circuit so that the required start voltage is higher than the shut down voltage to prevent repeated cycling on and off of the inverter, after shut down, due to the slight rise of battery voltage as the load is removed.

17. A method to provide power to a load from a renewable power source and an energy storage device, in which backup power is provided by a backup power source when the renewable energy source is not available and the stored power is depleted, comprising:
receiving power from a plurality of renewable energy sources which are isolated from one other;
charging at least one battery by receiving power from at least one of the renewable energy sources;
inverting the DC output from the battery to an AC output to match an AC backup power source; and
connecting the AC inverted output to a load, and switching to connect the AC backup power to the load when the battery voltage drops below a certain level.

18. The method of claim 17, including disconnecting all power to the load when AC backup power is unavailable, and connecting the battery charger circuit to the battery when the source of renewable energy is available.

19. The method of claim 17, including providing power from the battery to the inverter and load, and simultaneously charging the battery when the source of renewable energy is available and the stored energy in the battery is adequate to power the inverter and load.

20. The method of claim 17, including delaying the time of switching to change over between AC backup power and battery inverter power to reduce hunting due to fluctuating voltage.

21. The method of claim 17, wherein the AC backup power comprises at least one of an AC utility power line and stand-by AC generator.

22. The method of claim 17, comprising connecting the AC backup power indirectly by using at least one of a transformer and voltage converter/conditioner.

23. The method of claim 17, wherein the load is an electrically operated sign, light or other electrically powered item.

24. The method of claim 17, wherein the renewable energy source is at least one of solar power and wind power.

25. The method of claim 17, comprising isolating the energy sources using at least one of a diode and diode bridges.

26. The method of claim 17, wherein the battery comprises a bank of batteries.

27. The method of claim 17, comprising switching using a relay.

28. The method of claim 17, comprising switching using a time delay relay.

29. The method of claim 17, comprising selectively delivering power to the load.

30. The method of claim 29, comprising selectively delivering power to the load based on time of day, or based on ambient light conditions.

31. The method of claim 17, comprising detecting a low voltage condition before inverting, and in response to a low voltage condition terminating inverting to prevent excessive and life-shortening discharge of the battery.

32. The method of claim 17, comprising performing inverting with hysteresis so that the start voltage is higher than the shut down voltage to prevent repeated cycling on and off of the inverter, after shut down, due to the slight rise of battery voltage as the load is removed.
